(19) United States
(12) Patent Application Publication
(10) Pub. No.: US 2025/0263229 A1
(43) Pub. Date: Aug. 21, 2025

(54) PREVENTING DAMAGE TO AN INTERMEDIATE CONTAINER COUPLED WITH A REFUSE COLLECTION VEHICLE

(71) Applicant: The Heil Co., Chattanooga, TN (US)

(72) Inventors: Albert Xiaoxia Jiang, Chattanooga, TN (US); Bryan Kelly Stewart, Chattanooga, TN (US)

(21) Appl. No.: 19/054,092

(22) Filed: Feb. 14, 2025

Related U.S. Application Data
(60) Provisional application No. 63/554,453, filed on Feb. 16, 2024.

(51) Int. Cl. B65F 3/14; B65F 3/04

(52) U.S. Cl. CPC B65F 3/14; B65F 3/041; B65F 2003/146

(57) ABSTRACT

Systems and methods include a refuse collection vehicle including a chassis; a refuse collecting body supported by the chassis; and a front loading arm assembly coupled to the refuse collecting body. An intermediate container for receiving refuse is positioned in front of the refuse collection vehicle and coupled to the front loading arm assembly. At least one sensor is coupled to a portion of the refuse collection vehicle or to a portion of the intermediate container. The at least one sensor is oriented toward a road surface in front of the refuse collection vehicle. At least one processor communicably coupled to the at least one sensor, the at least one processor configured to perform operations including receiving a signal from the at least one sensor; and in response to receiving the signal, determining an elevation change of the road surface in front of the refuse collection vehicle.

### CROSS-REFERENCE TO RELATED APPLICATION

This application claims the benefit under 35 U.S.C. § 119(e) of U.S. Patent Application No. 63/554,453, entitled “Preventing Damage to an Intermediate Container Coupled with a Refuse Collection Vehicle,” filed Feb. 16, 2024, which is incorporated herein by reference in its entirety.

### TECHNICAL FIELD

This disclosure relates to systems and methods for operating a refuse collection vehicle.

### BACKGROUND

Refuse collection vehicles collect solid waste and transport the solid waste to landfills, recycling centers, or treatment facilities. The refuse collection routes driven by refuse collection vehicles can involve elevation changes in the road surface such as traffic calming devices (e.g., speed bumps), potholes in the road, and hills. An intermediate container for collecting refuse extending in front of the refuse collection vehicle reduces the vehicle approach angle increasing the potential for contact between the elevation changes of the road surface and the intermediate container. This contact can damage the intermediate container and the refuse collection vehicle.

### SUMMARY

In an example implementation, a refuse collection system includes a refuse collection vehicle including a chassis; a refuse collecting body supported by the chassis; and a front loading arm assembly coupled to the refuse collecting body; an intermediate container for receiving refuse positioned in front of the refuse collection vehicle and coupled to the front loading arm assembly; at least one sensor coupled to a portion of the refuse collection vehicle or to a portion of the intermediate container, the at least one sensor oriented toward a road surface in front of the refuse collection vehicle; and at least one processor communicably coupled to the at least one sensor, the at least one processor configured to perform operations including receiving a signal from the at least one sensor; and in response to receiving the signal, determining an elevation change of the road surface in front of the refuse collection vehicle.

In an aspect combinable with the example implementation, at least one sensor is coupled to the portion of the refuse collection vehicle and a detection distance of the at least one sensor is greater than a distance between a front side of the intermediate container and a front bumper of the refuse collection vehicle.

In another aspect combinable with any of the previous aspects, the detection distance is determined based at least in part on a speed of the refuse collection vehicle.

In another aspect combinable with any of the previous aspects, the detection distance is increased when the speed of the refuse collection vehicle exceeds a threshold speed.

In another aspect combinable with any of the previous aspects, the at least one sensor includes at least one of a radar sensor, a lidar sensor, a laser sensor, a stereo camera, a three-dimensional camera, or an ultrasonic sensor.

In another aspect combinable with any of the previous aspects, the elevation change includes a vertical deflection traffic calming device.

In another aspect combinable with any of the previous aspects, the elevation change includes an increase in the elevation of the road surface.

In another aspect combinable with any of the previous aspects, the operations further include in response to determining the elevation change, controlling the front loading arm assembly to change a position of the intermediate container.

In another aspect combinable with any of the previous aspects, controlling the front loading arm assembly to change the position of the intermediate container comprises controlling the front loading arm assembly to adjust at least one of the height and the angle of the intermediate container.

In another aspect combinable with any of the previous aspects, controlling the front loading arm assembly to change the position of the intermediate container occurs while the refuse collection vehicle is in motion.

In another aspect combinable with any of the previous aspects, controlling the front loading arm assembly to change the position of the intermediate container includes adjusting at least one of the height of the intermediate container or the angle of the intermediate container to a predetermined value.

In another aspect combinable with any of the previous aspects, the operations further include determining that the determined elevation change of the road surface in front of the refuse collection vehicle exceeds a threshold value, and in response, controlling the front loading arm assembly to change a position of the intermediate container.

In another aspect combinable with any of the previous aspects, the at least one sensor includes a sensor coupled to the portion of the intermediate container.

In another aspect combinable with any of the previous aspects, the sensor coupled to the portion of the intermediate container includes a mechanical sensor configured to be in contact with a surface on which the refuse collection vehicle is positioned when the intermediate container is in a lowered position.

In another aspect combinable with any of the previous aspects, the sensor coupled to the intermediate container is coupled to a front surface of the intermediate container.

In another aspect combinable with any of the previous aspects, the at least one processor includes an onboard computing device located in the refuse collection vehicle.

In another example implementation, a refuse collection system includes a refuse collection vehicle including a chassis; a refuse collecting body supported by the chassis; and a front loading arm assembly coupled to the refuse collecting body; an intermediate container for receiving refuse positioned in front of the refuse collection vehicle and coupled to the front loading arm assembly; at least one sensor coupled to a portion of the refuse collection vehicle or to a portion of the intermediate container, the at least one sensor oriented toward a road surface; and at least one processor communicably coupled to the at least one sensor, the at least one processor configured to perform operations including receiving a signal from the at least one sensor; and in response to receiving the signal, controlling the refuse collection vehicle to prevent damage to the intermediate container coupled to the front loading arm assembly of the refuse collection vehicle.

In another aspect combinable with the example implementation, the front loading arm assembly includes one or more position sensors; and the operations further include receiving signals from the one or more position sensors; and determining at least one of a height and an angle of the intermediate container with respect to a road surface on which the refuse collection vehicle is positioned.

In another aspect combinable with any of the previous aspects, controlling the refuse collection vehicle to prevent damage to the intermediate container comprises controlling the front loading arm assembly to adjust at least one of the height and the angle of the intermediate container.

In another aspect combinable with any of the previous aspects, controlling the refuse collection vehicle occurs while the refuse collection vehicle is in motion.

In another aspect combinable with any of the previous aspects, the controlling the front loading arm assembly includes adjusting at least one of the height of the intermediate container or the angle of the intermediate container to a predetermined value.

In another aspect combinable with any of the previous aspects, the operations further include determining that the determined elevation change of the road surface in front of the refuse collection vehicle exceeds a threshold value; and in response, controlling the front loading arm assembly to change a position of the intermediate container.

In another aspect combinable with any of the previous aspects, the at least one sensor includes at least one of a radar sensor, a lidar sensor, a laser sensor, a stereo camera, a three-dimensional camera, or an ultrasonic sensor.

In another aspect combinable with any of the previous aspects, the at least one sensor includes a sensor coupled to the portion of the intermediate container.

In another aspect combinable with any of the previous aspects, the sensor coupled to the portion of the intermediate container includes a mechanical sensor configured to be in contact with a surface on which the refuse collection vehicle is positioned when the intermediate container is in a lowered position.

In another aspect combinable with any of the previous aspects, the sensor coupled to the intermediate container is coupled to a front surface of the intermediate container.

In another aspect combinable with any of the previous aspects, the at least one sensor is coupled to the portion of the refuse collection vehicle and a detection distance of the at least one sensor is greater than a distance between a front side of the intermediate container and a front bumper of the refuse collection vehicle.

In another aspect combinable with any of the previous aspects, the detection distance is determined based at least in part on a speed of the refuse collection vehicle.

In another aspect combinable with any of the previous aspects, the detection distance is increased when the speed of the refuse collection vehicle exceeds a threshold speed.

In another aspect combinable with any of the previous aspects, the at least one processor is further configured to determine, based on the signal, an elevation change of the road surface in front of the refuse collection vehicle; and based on the elevation change of the road surface, control the refuse collection vehicle to change a position of the intermediate container to prevent contact between the intermediate container and the road surface.

In another aspect combinable with any of the previous aspects, the elevation change includes a vertical deflection traffic calming device.

In another aspect combinable with any of the previous aspects, the elevation change includes an increase in the elevation of the road surface.

In another aspect combinable with any of the previous aspects, the at least one processor includes an onboard computing device located in the refuse collection vehicle.

In another example implementation, a method of operating a refuse collection vehicle includes receiving a signal from at least one sensor coupled to a portion of the refuse collection vehicle or to a portion of the intermediate container, the at least one sensor oriented toward a road surface in front of the refuse collection vehicle; in response to receiving the signal, determining an elevation change of a road surface on which the refuse collection vehicle is positioned; and in response to determining an elevation change, controlling the refuse collection vehicle to prevent damage to an intermediate container for collecting refuse coupled to a front loading arm assembly of the refuse collection vehicle.

In another aspect combinable with any of the previous aspects, controlling the refuse collection vehicle to prevent damage to the intermediate container includes controlling the front loading arm assembly to raise the intermediate container.

Another aspect combinable with any of the previous aspects includes receiving a signal from one or more position sensors of the front loading arm assembly; and in response to receiving the signal from the one or more position sensors, determining at least one of a height of the intermediate container and an angle of the intermediate container with respect to a road surface on which the refuse collection vehicle is positioned.

In another aspect combinable with any of the previous aspects, raising the intermediate container includes adjusting at least one of the angle of the intermediate container relative to the road surface on which the refuse collection vehicle is positioned or the height of the intermediate container relative to the road surface on which the refuse collection vehicle is positioned to a predetermined value.

In another aspect combinable with any of the previous aspects, the at least one sensor includes at least one of a radar sensor, a lidar sensor, a laser sensor, a stereo camera, a three-dimensional camera, or an ultrasonic sensor.

Another aspect combinable with any of the previous aspects includes in response to receiving the signal, generating a visual alert or an audible alert.

In another aspect combinable with any of the previous aspects, the at least one sensor is coupled to the portion of the refuse collection vehicle and the detection distance is greater than a distance between a front side of the intermediate container and a front bumper of the refuse collection vehicle.

In another aspect combinable with any of the previous aspects, a detection distance of the at least one sensor depends on a current speed of the refuse collection vehicle.

In another aspect combinable with any of the previous aspects, the detection distance is increased when the speed of the refuse collection vehicle exceeds a threshold speed.

In another aspect combinable with any of the previous aspects, the at least one sensor is coupled to the portion of the intermediate container.

In another aspect combinable with any of the previous aspects, the at least one sensor coupled to the portion of the intermediate container includes a mechanical sensor in contact with the road surface.

In another aspect combinable with any of the previous aspects, receiving a signal includes receiving a signal indicating a deflection of the mechanical sensor in response to a change in elevation of the road surface.

Particular implementations of the subject matter described in this specification can be implemented so as to realize one or more of the following advantages.

For example, the refuse collection vehicle of the present disclosure can reduce the risk of damage to the vehicle by detecting elevation changes in surfaces proximate the refuse collection vehicle (e.g., road surfaces) using one or more distance sensors. In some implementations, the refuse collection vehicle of the present disclosure prevents damage to a coupled intermediate container carried by the vehicle by automatically controlling the angle and/or height of the intermediate container based on the detected elevation change.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 depicts an example system for collecting refuse.

FIG. 2 is a perspective view of a front-loader refuse collection vehicle with an integrated intermediate container.

FIG. 3 is a side, schematic view of the refuse collection vehicle of FIG. 2.

FIGS. 4A-4E are schematic illustrations of example traffic calming devices and elevation changes in the road surface.

FIG. 5 is a side, schematic view of a refuse collection vehicle with a mechanical distance sensor.

FIG. 6 is a perspective view of a refuse collection vehicle with an intermediate container integrated with the front loading arm assembly of the refuse container.

FIG. 7 is a schematic illustration of an example control system or controller for a refuse collection vehicle.

### DETAILED DESCRIPTION

The refuse collection system of the present disclosure includes one or more distance sensors. The distance sensor(s) of the refuse collection system can be used to detect one or more elevation changes of a surface (e.g., a road surface) proximate the refuse collection vehicle.

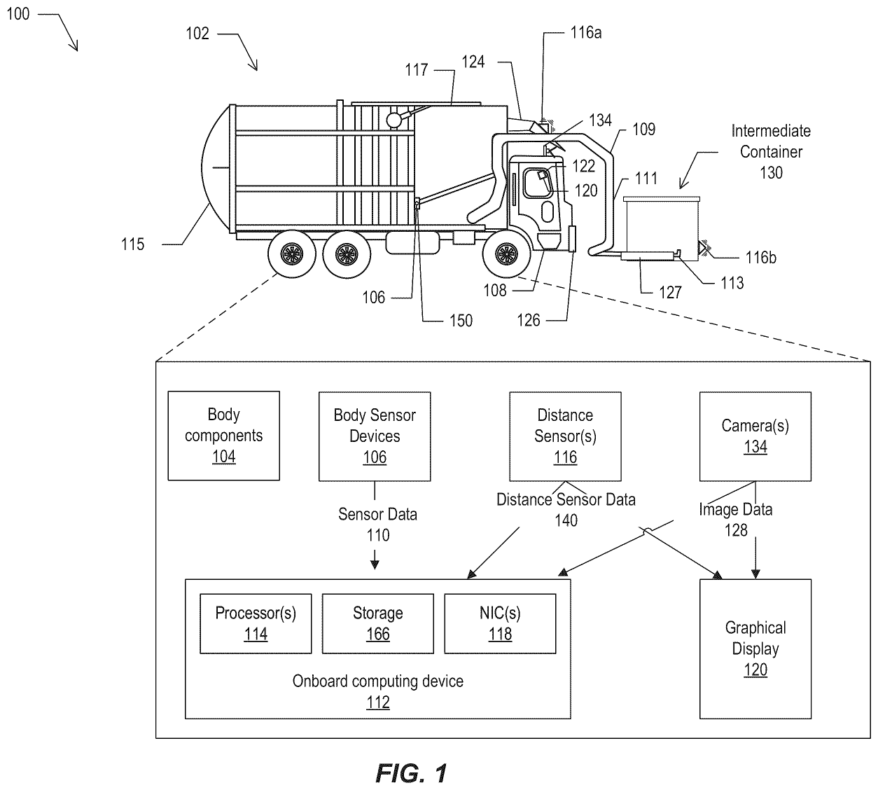

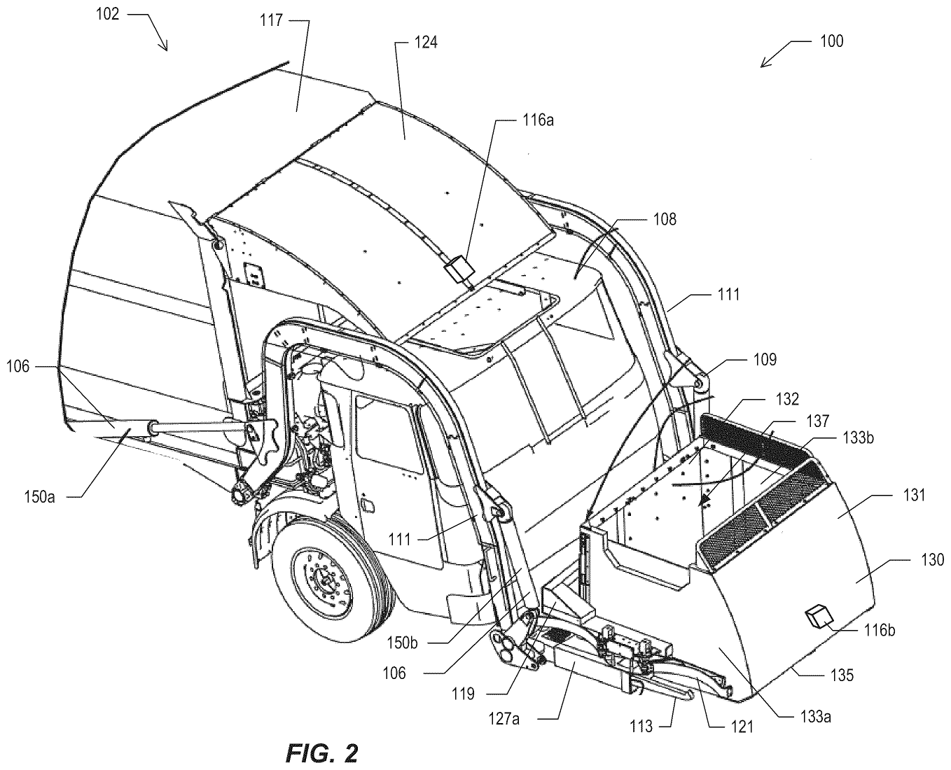

FIGS. 1-3 depict an example system 100 for collection of refuse including a refuse collection vehicle 102 and an intermediate container 130 coupled to the vehicle 102. Vehicle 102 is a refuse collection vehicle that operates to collect and transport refuse (e.g., garbage). The refuse collection vehicle 102 can also be described as a garbage collection vehicle, or garbage truck.

The vehicle 102 can include various body components 104 that are appropriate for the particular type of vehicle 102. For example, a front-loading vehicle (such as vehicle 102 of FIGS. 1-3) includes various body components 104 including, but not limited to: a front loading arm assembly 109 which includes a lift arm 111 and forks 113, a back gate or tailgate 115, and a hopper 117 to collect refuse for transportation. The vehicle 102 may include other types of components that operate to bring garbage into a hopper 117 of the vehicle 102, compress and/or arrange the garbage in the vehicle 102, and/or expel the garbage from the vehicle 102.

Front end loading refuse collection vehicles (such as vehicle 102) are typically used for commercial refuse collection, where large bins of garbage or recyclables are engaged with the front forks of the vehicle and lifted overhead to be emptied into a hopper behind the cab of the vehicle. In order to service residential refuse containers (also referred to herein as residential bins), an intermediate container, such as intermediate container 130, can be coupled to the forks of a front end loading refuse collection vehicle and used to collect refuse from residential refuse containers. U.S. Pat. Nos. 7,210,890 and 7,553,121, which are incorporated by reference in their entirety herein, describe example intermediate containers which can be positioned on the front forks of a front end loading refuse collection vehicle. An example intermediate container for collecting refuse is sold under the brand Curotto-Can®.

Referring to FIGS. 1-3, an intermediate container 130 for collecting refuse is coupled to the front loading arm assembly 109 of the vehicle 102. The intermediate container 130 has an overall box shape with a front wall 131, a rear wall 132, sidewalls 133a, 133b, a bottom 135 and an open top 137. Refuse can be positioned into the intermediate container 130 through the open top 137. The intermediate container 130 includes a pair of channels 127a, 127b extending along the sidewalls 133a, 133b that allow the forks 113 to pass through to enable the vehicle 102 to lift and transport the intermediate container 130. The intermediate container 130 can remain coupled to the front loading arm assembly 109 while the vehicle 102 is in motion.

The intermediate container includes a collection arm 119 is coupled to the intermediate container 130 and configured to engage, lift, and invert a refuse container (e.g., a residential refuse bin) to empty the contents of the refuse container into the intermediate container 130. A portion of the collection arm 119 is positioned inside of the intermediate container 130. The collection arm 119 includes a grabber assembly 121. The grabber assembly 121 can be extended, retracted, and rotated to grab refuse cans (e.g., residential refuse bins) and empty the refuse cans into the intermediate container 130. The refuse is retained in the intermediate container 130 until it is dumped into the hopper 117 of the vehicle 102. Once the intermediate container 130 is sufficiently full, the lift arm 111 and front loading arm assembly 109 of the vehicle 102 lift the intermediate container 130 to dump its contents into the hopper 117 of the vehicle 102.

The vehicle 102 can include any number of body sensor devices 106 that sense body component(s) 104 and generate sensor data 110 describing the operation(s) and/or the operational state of various body components. The body sensor devices 106 are also referred to as sensor devices, or sensors. Sensors can be arranged in the body components, or in proximity to the body components, to monitor the operations of the body components. The body sensor devices 106 emit signals that include the body sensor data 110 describing the body component operations, and the signals may vary appropriately based on the particular body component being monitored. Body sensor devices 106 can be provided on the vehicle body to evaluate cycles and/or other parameters of various body components. For example, as described in further detail herein, the sensors 106 can detect and/or measure the particular position and/or operational state of body components such as the front loading arm assembly 109, the lift arm 111, the forks 113, and so forth.

Body sensor devices 106 can include, but are not limited to, an analog sensor, a digital sensor, a CAN bus sensor, a magnetostrictive sensor, a radio detection and ranging (Radar) sensor, a light detection and ranging (LIDAR) sensor, a laser sensor, an ultrasonic sensor, an infrared (IR) sensor, a stereo camera sensor, a three-dimensional (3D) camera, in-cylinder sensors, or a combination thereof. In some implementations, the body sensor devices 106 may be incorporated into the various body components. Alternatively, or additionally, the body sensor devices 106 may be separate from the body components.

The system 100 can also include one or more distance sensors 116a, 116b (collectively referred to herein as distance sensors 116) that can be used to detect elevation changes of the surface on which the vehicle 102 is positioned (e.g., a road surface). For example, as will be described in further detail herein, the distance sensor(s) 116 can be used to detect vertical deflection traffic calming devices (e.g., speed bumps, speed tables, speed cushions, etc.), dips, and inclines (e.g., hills, entrances to driveways or parking lots, etc.). Distance sensors 116 can include sensors similar to the body sensor devices 106. For example, the distance sensors 116 can include radar sensors, LIDAR sensors, ultrasonic sensors, laser-based distance sensors, stereo camera sensors, three-dimensional cameras (e.g., plenoptic cameras), and mechanical displacement sensors. Distance sensors 116 can be positioned on the vehicle 102 and/or on the intermediate container 130. For example, as depicted in FIGS. 1-3, a first distance sensor 116a can be coupled to an upper surface of the cab protector 124 of the vehicle 102 and a second distance sensor 116b can be coupled to a front surface 131 of the intermediate container 130. In some implementations, one or more body components 104 of the vehicle 102 can be controlled based on the output of the distance sensors 116.

In some implementations, the distance sensors 116 are radar sensors configured to generate radar sensor data, such as a point cloud. The point cloud generated by the radar sensors includes a discrete set of data points in a two-dimensional (2D) coordinate system. Each data point in the point clouds generated by the respective radar sensor has a set of Cartesian coordinates (X, Y) and represents a single point on a surface proximate the vehicle 102 (e.g., road surface) detected by the respective radar sensor. The Cartesian coordinates of the data points in the point cloud can be used to determine the angle and distance of the surface relative to the radar sensor. The point clouds generated by the radar sensors 116 can be processed in order to detect and identify elevation changes in surfaces proximate the vehicle 102, such as curbs, dips, speed bumps, and hills. In some implementations, point clouds are generated at a predefined time interval based on updated data received from the radar sensors to create a set of point clouds, and the set of point clouds can be processed to detect elevation changes proximate the vehicle 102. For example, a new point cloud can be generated every 30-40 milliseconds based on updated data received from the radar sensors, and two or more point clouds generated consecutively can be processed in combination to detect elevation changes of surfaces proximate the vehicle 102 as the vehicle 102 moves through an environment.

In some implementations, the body sensor data 110 and distance sensor data 140 is communicated from the body sensor devices 106 and the distance sensors 116 to an onboard computing device 112 in the vehicle 102. In some instances, the onboard computing device is an under-dash device (UDU) and may also be referred to as the Gateway. Alternatively, the device 112 can be placed in some other suitable location in or on the vehicle. The body sensor data 110 and distance sensor data 140 can be communicated from the body sensor devices 106 and the distance sensors 116, respectively, to the onboard computing device 112 over a wired connection (e.g., an internal bus) and/or over a wireless connection. In some implementations, a Society of Automotive Engineers standard J1939 bus in conformance with International Organization of Standardization (ISO) standard 11898 connects the various sensors with the onboard computing device. In some implementations, a Controller Area Network (CAN) bus connects the various body sensor devices 106 and the distance sensors 116 with the onboard computing device 112. For example, a CAN bus in conformance with ISO standard 11898 can connect the various sensors with the onboard computing device 112. In some implementations, body sensor devices 106 and/or the distance sensors 116 digitize the signals that communicate the sensor data 110, 140 before sending the signals to the onboard computing device 112 if the signals are not already in a digital format.

The analysis of the body sensor data 110 and the distance sensor data 140 can be performed at least partly by the onboard computing device 112, e.g., by processes that execute on the processor(s) 114. For example, the onboard computing device 112 can execute processes that perform an analysis of the body sensor data 110 to determine the current position of the body components 104, such as the lift arm position or the fork assembly position. In some implementations, an onboard program logic controller or an onboard mobile controller perform analysis of the body sensor data 110 to determine the current position of the body components 104. The onboard computing device 112 can execute processes that perform an analysis of the distance sensor data 140 to detect elevation changes of surfaces proximate the vehicle 102. In some implementations, an onboard programable logic controller or an onboard mobile controller perform analysis of the distance sensor data 140 to detect elevation changes of surfaces proximate the vehicle 102.

The onboard computing device 112 can include one or more processors 114 that provide computing capacity, data storage 166 of any suitable size and format, and network interface controller(s) 118 that facilitate communication of the onboard computing device 112 with other device(s) over one or more wired or wireless networks.

In some implementations, the vehicle 102 includes a body controller that manages and/or monitors various body components 104 of the vehicle 102. The body controller of the vehicle 102 can be connected to multiple sensors in the body of the vehicle. The body controller can transmit one or more signals over the J1939 network, or other wiring on the vehicle, when the body controller senses a state change from any of the sensors. These signals from the body controller can be received by the onboard computing device 112 that is monitoring the J1939 network.

In some implementations, the onboard computing device 112 is a multi-purpose hardware platform. The device can include a under dash unit (UDU) and/or a window unit (WU) (e.g., camera) to record video and/or audio operational activities of the vehicle. The onboard computing device hardware subcomponents can include, but are not limited to, one or more of the following: a CPU, a memory or data storage unit, a CAN interface, a CAN chipset, NIC(s) such as an Ethernet port, USB port, serial port, I2c lines(s), and so forth, I/O ports, a wireless chipset, a global positioning system (GPS) chipset, a real-time clock, a micro SD card, an audio-video encoder and decoder chipset, and/or external wiring for CAN and for I/O. The device can also include temperature sensors, battery and ignition voltage sensors, motion sensors, CAN bus sensors, an accelerometer, a gyroscope, an altimeter, a GPS chipset with or without dead reckoning, and/or a digital can interface (DCI). The DCI cam hardware subcomponent can include the following: CPU, memory, can interface, can chipset, Ethernet port, USB port, serial port, I2c lines, I/O ports, a wireless chipset, a GPS chipset, a real-time clock, and external wiring for CAN and/or for I/O. In some implementations, the onboard computing device 112 is a smartphone, tablet computer, and/or other portable computing device that includes components for recording video and/or audio data, processing capacity, transceiver(s) for network communications, and/or sensors for collecting environmental data, telematics data, and so forth.

In some implementations, one or more cameras 134 can be mounted on the vehicle 102 or otherwise present on or in the vehicle 102. The camera(s) 134 each generate image data 128 that includes one or more images of a scene external to and in proximity to the vehicle 102. In some implementations, one or more cameras 134 are arranged to capture image(s) and/or video of the intermediate container 130 before, after, and/or during the operations of body components 104 to engage and empty the intermediate container 130. For example, for a front-loading vehicle, the camera(s) 134 can be arranged to image objects in front of, above, and/or behind the vehicle 102. In some implementations, the camera(s) 134 can capture video of a scene external to, internal to, and in proximity to the vehicle 102. In some implementations, the camera(s) 134 are controlled to capture image data and/or video data of elevation changes detected by the distance sensors 116 coupled to the refuse collection vehicle 102.

In some implementations, the camera(s) 134 are communicably coupled to a graphical display 120 to communicate images and/or video captured by the camera(s) 134 to the graphical display 120. In some implementations, the graphical display 120 is placed within the interior of the vehicle. For example, the graphical display 120 can be placed within the cab 108 of vehicle 102 such that the images and/or video can be viewed by an operator of the vehicle 102 on a screen 122 of the graphical display 120. In some implementations, the graphical display 120 is a heads-up display that projects the images and/or video captured by the camera(s) 134 onto the windshield of the vehicle 102 for viewing by an operator of the vehicle 102. In some implementations, the images and/or video captured by the camera(s) 134 can be communicated to a graphical display 120 of the onboard computing device 112 in the vehicle 102. Images and/or video captured by the camera(s) 134 can be communicated from the sensors to the onboard computing device 112 over a wired connection (e.g., an internal bus) and/or over a wireless connection. In some implementations, a network bus (e.g., a J1939 network bus, a CAN network bus, etc.) connects the camera(s) with the onboard computing device 112. In some implementations, the camera(s) are incorporated into the various body components 104. Alternatively, the camera(s) may be separate from the body components 104.

One or more body sensor devices 106 can be situated to determine the state and/or detect the operations of the body components 104. In the example shown, the vehicle 102 includes a body sensor device 106 that is arranged to detect the position of the lift arm 111 and/or the forks 113. For example, the body sensor device 106 can provide data about the current position of the lift arm 111 and the forks 113 throughout a cycle to dump refuse from the intermediate container 130 into the vehicle 102. In some implementations, the body sensor device(s) 106 are located in one or more cylinders 150a, 150b (collectively referred to herein as cylinders 150) of the refuse collection vehicle 102. In some examples, body sensor device 106 is located inside a cylinder 150a used for raising the lift arm 111 and a body sensor device 106 is located inside a cylinder 150b used for moving the front loading arm assembly 109. In some implementations, body sensor device 106 is located on the outside of a housing containing the cylinder 150a coupled to the lift arm 111. In some examples, the body sensor devices 106 are in-cylinder, magnetostrictive sensors.

In some implementations, the vehicle 102 includes one or more cameras 134 oriented to capture images of the exterior of the vehicle 102. For example, the cameras 134 can be configured to capture image data or video data of a scene external to and in proximity to the vehicle 102, such as in a direction of travel of the vehicle 102, behind the vehicle 102, or above the vehicle 102. In some implementations, the image data or video data captured by the camera(s) 134 can be combined with data captured by the distance sensors 116 to detect and track elevation changes in the road surface proximate the vehicle 102. In some implementations, the image data 128 and the distance sensor data 140 are combined to generate a map of elevation changes in the road surface.

Referring to FIGS. 1-3, the system 100 includes a first distance sensor 116a coupled to an upper surface of the cab protector 124 of the vehicle 102 and a second distance sensor 116b coupled to a front surface 131 of the intermediate container 130. The distance sensors 116 are oriented toward the road surface 302 in front of the vehicle 102 and are configured to detect changes in elevation in the road surface 302 in front of the vehicle 102. Distance sensors 116 can include radar sensors, LIDAR sensors, ultrasonic sensors, laser-based distance sensors, stereo camera sensors, three-dimensional cameras (e.g., plenoptic cameras), and mechanical displacement sensors. The distance sensors 116 can each be the same type of distance sensor or different types of distance sensors. In addition, the distance sensors 116 can each have similar sensitivities or can have different sensitivities. For example, distance sensor 116b can have a higher sensitivity than distance sensor 116a or vice versa.

In some implementations, the data from the distance sensors 116a, 116b can be processed to triangulate elevation changes in the road surface 302, for example, when distance sensors 116 are configured to detect the road surface 302 at the same distance in front of the vehicle 102. In some implementations, the distance sensors 116a, 116b can be directed toward different portions of the road surface 302. For example, the distance sensor 116a can be directed at a location further in front of vehicle 102 than distance sensor 116b. Distance sensor 116a can measure a first elevation at a first location, and distance sensor 116b can measure a second elevation at a second location that is closer to the vehicle 102 that then first location, and changes in elevation of the road surface 302 can be determined based on a difference between the first elevation and the second elevation and the known distance between the first location and the second location. In some implementations, the distance sensors 116 and onboard computing device 112 measure and store distances at multiple instances in time. For example, a first distance is detected at a first time, and a second distance is detected at a second time. The onboard computing device 112 can determine an elevation change based on a difference between the first distance and the second distance. For example, if the second distance is smaller than the first distance, the onboard computing system can determine that there is an increasing elevation.

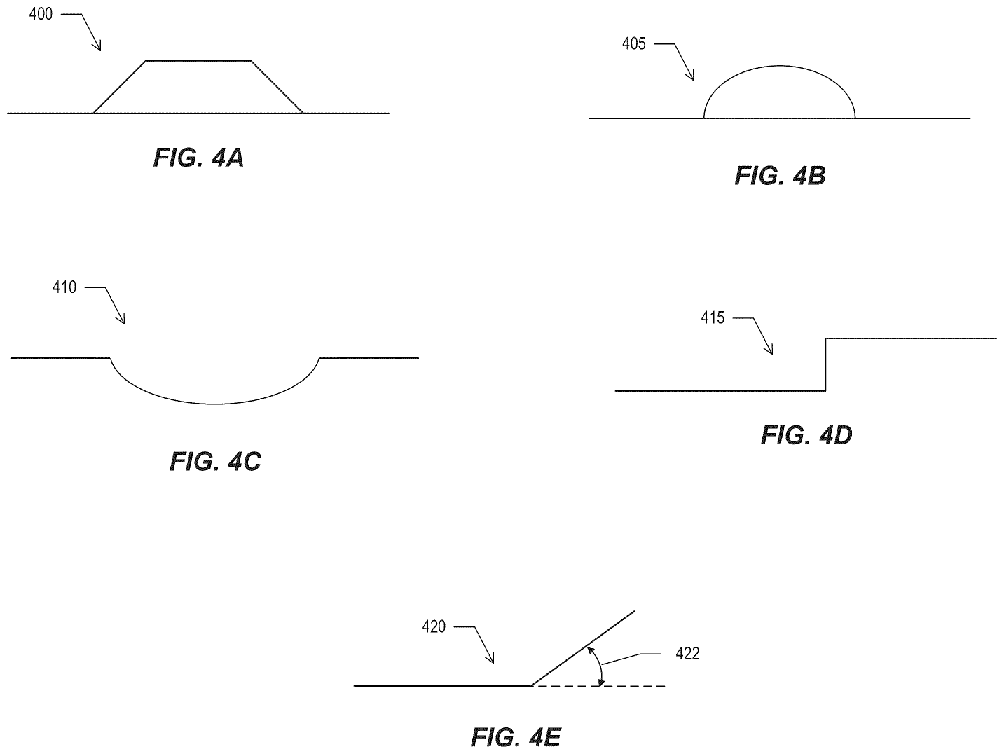

FIGS. 4A-4E depict various types of elevation changes in a road surface that can be detected by the distance sensors 116. FIGS. 4A-4C are schematic examples of vertical deflection traffic calming devices that cause elevation changes in the road surface. Vertical deflection traffic calming devices include, for example, speed tables 400, speed bumps or speed humps 405, and dips 410. Vertical deflection traffic calming devices are engineered to help reduce speeds on a road by raising or lowering the road surface to cause discomfort to passengers if traversed at a too high of a speed.

FIGS. 4D-4E are schematic examples of other elevation changes that can occur on a road surface. FIG. 4D shows a vertical step 415 change in the elevation of the road surface. The vertical step 415 can be caused by, for example, a curb along the edge of a road or at the end of a cul-de-sac. FIG. 4E shows an angled incline 420 with an inclination angle 422 relative to a horizontal plane. The angled incline 420 can represent elevation changes resulting from topographical features (e.g., hills, valleys) of the Earth or structural features of the roadway (e.g., bridges, on/off ramps). Angled incline 420 can also occur, for example, at an entrance to a parking lot or driveway that the refuse collection vehicle may need to enter to collect refuse.

In implementations, one or more of distance sensors 116 are radar sensors and an antenna of each of the radar sensors emits radio waves (e.g., electromagnetic radiation) outwards from the respective radar sensor toward the road surface 302 in front of the vehicle 102. The radio waves emitted by the radar sensors contact and reflect off of the road surface 302. The reflected radio waves are detected by a receiver of the respective radar sensor. For example, a radio wave emitted from a radar sensor (e.g., distance sensor 116b) positioned on the front surface 131 of the intermediate container 130 can reflect off of the road surface 302 and return to the radar sensor, and the reflected radio wave can be analyzed to detect changes in the elevation of the road surface 302.

In some implementations, the distance sensors 116 are configured to take measurements at a predefined time interval. For example, the distance sensors 116a, 116b can be configured to take distance measurements every 30 milliseconds or less.

In some implementations, the distance sensors 116 are laser-based distance sensors, and a laser beam of the laser-based distance sensors is oriented toward the road surface 302 in order to detect changes in elevation in the road surface 302 in front of the vehicle 102. For example, light from the laser beam generated by the distance sensors 116 reflects off the road surface 302 and returns to a light detector of the laser-based distance sensor 116. The laser-based distance sensor can determine the distance to the road surface 302 based on the round trip time-of-flight of the light.

In some implementations, one or more distance sensors 116 is a camera. Image data or video data captured by the camera can be used to detect elevation changes in the road surface. For example, the image data or video data can be processed by a machine learning model to detect elevation changes. The machine learning model can be trained by training data including images labeled with appropriate labels indicating a type and height of the elevation change. The image data or video data can be processed by the onboard computing device 112 to determine an elevation change in front of the vehicle 102.

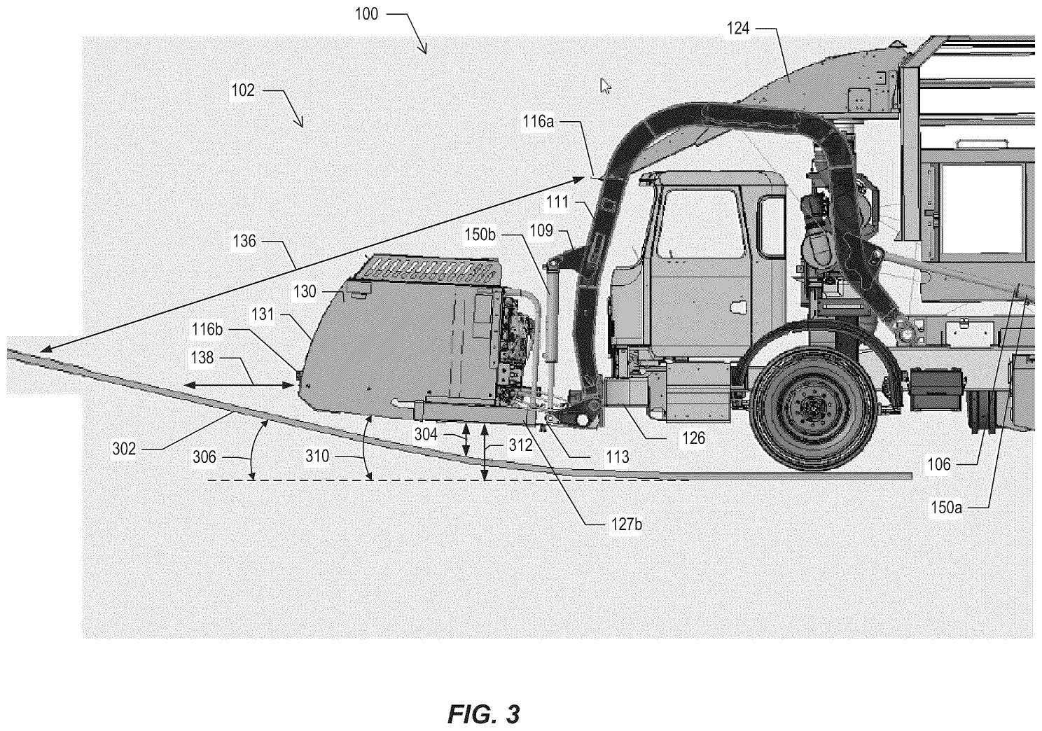

Referring to FIG. 3, the distance sensors 116a and 116b can be configured to detect elevation changes within a particular detection distance 136 and 138, respectively, relative to the distance sensor 116a and 116b. In some implementations, the distance sensors 116a, 116 have the same detection distance 136, 138. In some implementations, the distance sensors 116a, 116 have the different detection distances 136, 138. For example, the detection distances 136, 138 of the distance sensors 116a, 116b can depend on the location of the distance sensor 116 on the vehicle. For example, in some implementations, the detection distance 136 of the distance sensor 116a coupled to the cab protector 124 is greater than the detection distance 138 of the distance sensor 116b coupled to the intermediate container 130. In some implementations, the distance sensor 116a has a detection distance 136 that is greater than the distance between the front side 131 of the intermediate container 130 and the front bumper 126 of the vehicle 102.

In some implementations, the detection distance 136, 138 for each distance sensor 116 is a fixed distance away from the respective distance sensor 116a, 116b. In implementations, the sensors 116a and 116b can have detection distances 136, 138 that enable detection of the road surface at different points relative to the front bumper 126 of the vehicle 102. For example, distance sensor 116a can have a detection distance 136 that enables detection of elevation changes in the road surface further in front of the vehicle 102 than distance sensor 116b. In some implementations, distance sensor 116b coupled to the intermediate container can be a distance sensor with a shorter detection distance and/or a higher sensitivity than the distance sensor 116a coupled to the cab protector 124. A higher sensitivity for distance sensor 116b can be beneficial to detect smaller elevation changes in the road surface. For example, at an incline, the elevation change is relatively small over the detection distance 138, which may need a higher sensitivity to detect, as compared with the elevation change over the detection distance 136.

In some implementations, the detection distance 136, 138 of the distance sensors 116a, 116b can be adjusted based on a speed of the vehicle 102. For example, the detection distance 136, 138 can be increased when the speed of the vehicle 102 exceeds a threshold speed. For example, a laser beam from a laser-based distance sensor can be directed further in front of the vehicle 102 when it is detected that the vehicle 102 is traveling at higher speeds.

In some implementations, the distance sensors 116 are the same type of sensor. In some implementations, the distance sensors 116 are different types of distance sensors. For example, distance sensor 116a can be a radar sensor, and distance sensor 116b can be a laser-based sensor. Alternatively, or additionally, distance sensor 116a can be a laser-based sensor and distance sensor 116b can be an ultrasonic sensor. Other combinations of distance sensors are also possible.

In some implementations, multiple distance sensors 116 are positioned on the intermediate container 130. By including multiple distance sensors 116 positioned on the intermediate container 130, data from the multiple distance sensors can be used to triangulate elevation changes in the road surface 302 and determine features of the surface including, for example, inclination angle 306 and heights of vertical deflection traffic calming devices (e.g., traffic calming devices 400-415).

In some implementations, a user (e.g., an operator of the vehicle 102) can set the detection distance 136, 138 of the distance sensors 116. For example, the user can increase or decrease the distance relative to a default detection distance.

In some implementations, one or more distance sensors 116 can transmit a CAN message to the onboard computing device 112 of the vehicle 102 indicating a detected elevation change in the road surface. For example, a distance sensor 116a can transmit a CAN message to the onboard computing device 112 of the vehicle 102 indicating the road surface in front of the vehicle 102 has an increasing elevation within the detection distance 136 of the distance sensor 116a. Similarly, the distance sensor 116b can transmit a CAN message to the onboard computing device 112 of the vehicle 102 indicating a change in elevation in front of the vehicle 102 within the detection distance 138 of the distance sensor 116b. In some implementations, the distance sensors 116a, 116b transmit a CAN message to the onboard computing device 112 of the vehicle 102 indicating an angle 306 of elevation change in the road surface relative to the vehicle 102. In some implementations, in response to detecting an elevation change, the distance sensors 116a, 116b can transmit a CAN message to the onboard computing device 112 as a digital (e.g., discrete) output, for example, a positive indication that an elevation change occurs within the respective detection distance 136, 138 of the distance sensors 116a, 116b.

In response to receiving a signal from one or more of the distance sensors 116a, 116b indicating that the road surface has an elevation change, the onboard computing device 112 can perform one or more actions to respond to the detected elevation change. In some implementations, the onboard computing device 112 controls one or more body components 104 of the vehicle 102 in order to prevent or mitigate contact between the intermediate container 130 and the road surface 302.

For example, in response to receiving a signal from the distance sensor 116a or 116b, the onboard computing device 112 can determine whether an elevation change of the road surface 302 is greater than a threshold elevation change. For example, the onboard computing device 112 can determine that the elevation change of the road surface exceeds a threshold angle (e.g., the vehicle approach angle). In some implementations, the threshold elevation change corresponds to an amount of elevation change that would likely result in contact between the intermediate container 130 and the road surface 302.

In response to determining that an elevation change of the road surface 302 detected by the distance sensors 116 exceeds a threshold elevation change, the onboard computing device 112 can control the front loading arm assembly 109 to change a position of the intermediate container 130. For example, in response to determining that an elevation change of the road surface 302 detected by the distance sensors 116 exceeds a threshold elevation change, the onboard computing device 112 can generate commands to raise the intermediate container 130. The commands to raise the intermediate container 130 can include, for example, changing an angle of the intermediate container 130 by actuating cylinder 150b to tilt the forks 113. The onboard computing device 112 can also raise the intermediate container by moving lift arms 111 by actuating cylinder 150a.

In some implementations, the onboard computing device 112 determines a target angle and/or height of the intermediate container. For example, the onboard computing device 112 determines a target angle and/or height of the intermediate container 130 that will prevent contact between a detected elevation change and the intermediate container 130. In some implementations, the target angle and/or height is a predetermined value (e.g., a fixed value). The target angle and/or height can be based, for example, on the vehicle approach angle of the vehicle 102 without the intermediate container 130 extending in front of the vehicle 102. In some implementations, the onboard computing device 112 includes a maximum angle and/or height to which the intermediate container can be adjusted in response to detecting an elevation change to, for example, prevent the intermediate container 130 from blocking the view of the driver while vehicle 102 is in motion. In some implementations, the predetermined value of the target angle and/or height is equal to the maximum allowed angle and/or height of the intermediate container 130 while the vehicle is in motion.

In some implementations, the onboard computing device 112 determines the target angle/height based on a minimum ground clearance (e.g., a smallest allowed distance) between the bottom of the intermediate container 130 and the road surface 302. For example, the onboard computing device 112 determines a current ground clearance 304 of the intermediate container 130 relative to the ground surface 302 on which the vehicle 102 is currently positioned based on the size and position of the intermediate container 130 and data received from on one or more body sensors 106 indicating the position of the front loading arm assembly 109. The onboard computing device 112 can determine an angle 306 of the road surface 302 in front of the vehicle 102 based on signals from the distance sensors 116. The onboard computing device 112 can then determine a predicted ground clearance of the intermediate container 130 when positioned over the detected surface 302 in front of the vehicle based on the current amount of ground clearance 304 of the intermediate container 130 over the road surface upon which the vehicle 102 is presently positioned and the angle 306 of the road surface 302 that is detected by the distance sensors 116. The onboard computing device 112 can determine the target angle and/or height to which to raise the intermediate container 130, for example, based on the difference between the predicted ground clearance 304 and the minimum ground clearance. For example, in response to determining that the predicted ground clearance 304 for the intermediate container 130 for the detected ground surface 302 is below a threshold value (e.g., minimum ground clearance), the onboard computing device 112 determines a target angle and/or height of the intermediate container 130 that will result in the predicted ground clearance 304 meeting or exceeding the minimum ground clearance.

In response to determining the target angle and/or height, the onboard computing system controls the cylinders 150 to achieve the target angle and/or height based on feedback including position data from body sensors 106. For example, the onboard computing device 112 receives signals from one or more body sensor devices 106 indicating the current position of the lift arm 111 and the forks 113 and controls the lift arm 111 and/or forks 113 to achieve the target angle. The onboard computing device 112 can continue to raise the intermediate container 130 until the onboard computing device has determined the target angle and/or height of the intermediate container 130 based on signals received from one or more body sensors 106. For example, the onboard computing device 112 can determine that the target angle and/or height of the intermediate container 130 has been achieved based on receiving a signal from the one or more body sensors 106 indicating that the current position of the lift arm 111 and/or forks 113 correspond to the target height and/or angle, respectively. In some implementations, controlling the lift arm 111 and/or the forks 113 to change the position of the intermediate container occurs while the vehicle 102 is in motion.

In some implementations, in response to receiving a signal from the distance sensor 116 indicating that an elevation change exceeding an elevation change threshold is within the detection distance 136, 138 of the distance sensors 116, the onboard computing device 112 can control the vehicle 102 to reduce its speed of travel below a threshold speed in order to mitigate damage caused by the vehicle 102 driving over the elevation change.

In some implementations, the onboard computing device 112 stores geographical locations (e.g., global positioning system (GPS) coordinates) of detected elevation changes in a database. Entries in the database can include, for example, the location of the elevation change, the height of the elevation change, and/or an indicator of whether the elevation change can be traversed without damage to the intermediate container 130. In some implementations, a computing device (e.g., onboard computing device 112 or a remote computing device) accesses entries of the database during route planning for vehicles, for example, to plan routes that avoid road surfaces with elevation changes above a threshold value and/or impassable elevation changes. In some implementations, the onboard computing device 112 accesses one or more entries of the database while the vehicle 102 is in motion and determines target angles and/or heights of the intermediate container based on the one or more database entries.

An example process for detecting an elevation change of a road surface 302 in front of the vehicle 102, will now be described with reference to FIGS. 1-3. As depicted in FIG. 3, while driving along a refuse collection route, a vehicle 102 may approach a hill (or other feature) causing an elevation change in the road surface 302 (e.g., as represented by angle 306) that may potentially cause damage to vehicle 102 or intermediate container 130. As the vehicle 102 travels along the road surface 302, the distance sensors 116 are oriented toward the road surface 302 and generate signals indicating a distance between the respective distance sensor 116 and the road surface 302 (e.g., within the respective detection distances 136, 138) in front of the vehicle 102. In some implementations, the onboard computing device 112 increases the detection distance of the distance sensors 116 when the speed of the vehicle 102 exceeds a threshold speed.

The onboard computing device 112 receives a signal from at least one distance sensor 116 coupled to the vehicle 102, and in response to receiving the signal, the onboard computing device 112 determines an elevation change 306 of the road surface 302 in front of the refuse collection vehicle 102. For example, the onboard computing device 112 can determine an elevation change of the road surface 302 based on a signal indicating a distance that is different than an expected distance. The elevation change can be determined based on a difference in distances indicated by two or more distance sensors 116. For example, the distance sensor 116a can be directed at a different location in front of vehicle 102 than distance sensor 116b. Distance sensor 116a can measure a first elevation at the first location, and distance sensor 116b can measure a second elevation at the second location, and changes in elevation in the road surface 302 in front of the vehicle 102 can be determined based on the distance between the first location and the second location and the difference between the first elevation at the first location and the second elevation at the second location.

In some implementations, the elevation change is determined based on the signal indicating a distance that is different than a previously received signal. For example, a first distance is detected at a first time by a distance sensor 116, and a second distance is detected at a second time by the distance sensor 116, and the onboard computing device 112 can determine an elevation change based on a difference between the first distance and the second distance detected by the distance sensor 116. For example, if the second distance is smaller than the first distance, the onboard computing system can determine that there is an increasing elevation. In some implementations, the distance sensors 116 send signals to the onboard computer at predefined time intervals, for example, every 30 milliseconds or less, every 50 milliseconds or less, or every 100 milliseconds or more. The onboard computing device 112 can record in memory or storage the distances indicated by distance sensors at each moment in time that a signal is received.

In some implementations, the onboard computing device 112 compares the detected elevation change 306 with a threshold elevation change. For example, the threshold elevation change can indicate a maximum elevation change that can be traversed without damaging the intermediate container 130. For elevation changes below the threshold elevation change, the onboard computing device can determine that no further action is necessary to prevent contact between the intermediate container 130 and the road surface 302.

In response to determining an elevation change of the road surface 302 exceeds a threshold elevation change, the onboard computing device 112 controls the refuse collection vehicle 102 to prevent damage to the intermediate container 130. Controlling the refuse collection vehicle 102 to prevent damage to the intermediate container 130 includes controlling the lift arm 111 and/or the front loading arm assembly 109 to raise the intermediate container 130. For example, the onboard computing device receives a signal from one or more position sensors 106 of the front loading arm assembly 109. In response to receiving the signal from the one or more position sensors 106, the onboard computing device determines at least one of a height and an angle of the intermediate container 130 with respect to the road surface 302 on which the refuse collection vehicle 102 is positioned.

Raising the intermediate container 130 can include adjusting at least one of the angle 310 of the intermediate container 130 relative to the road surface on which the refuse collection vehicle is positioned and the height 312 of the intermediate container 130 relative to the road surface on which the refuse collection vehicle 102 is positioned. For example, the angle 310 of the intermediate container 130 can be adjusted by rotating the forks 113. The height 312 of the intermediate container 130 can be adjusted by raising or lowering the lift arms 111.

In some implementations, in response to receiving the signal from the distance sensor 116, the onboard computing device 112 generates a visual alert or an audible alert to notify the operator of the vehicle 102 of the upcoming elevation change in the road surface 302. For example, in response to receiving the signal from the distance sensor 116, the onboard computing device 112 can generate an alert that displays on graphical display 120 positioned within the cab 108 of the vehicle 102 and can be viewed by an operator (e.g., driver) of the vehicle 102. In some implementations, the onboard computing device 112 generates an alert when the detected elevation change in the road surface 302 in front of the vehicle 102 exceeds a threshold elevation change.

In some implementations, a user (e.g., vehicle driver) can override the control signals sent by the onboard computing device. For example, an operator of the vehicle 102 can stop movement of the front loading arm assembly 109 or change the position of the intermediate container to a different position.

While certain embodiments have been described, other embodiments are possible.

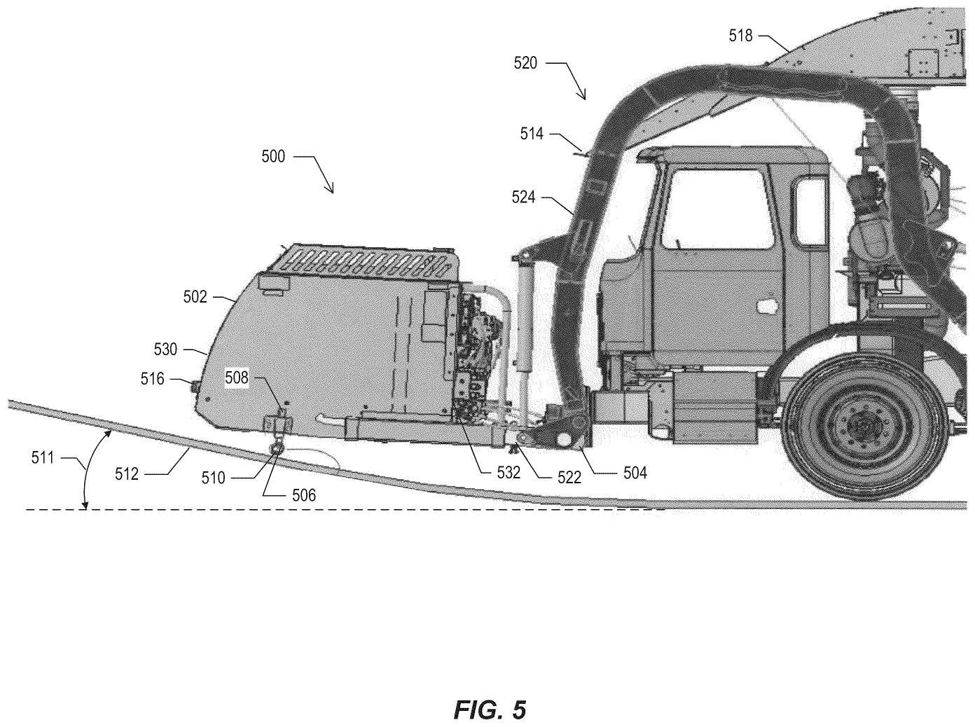

For example, while the distance sensors 116 have been described as electronic distance measuring sensors, in some implementations, one or more of the distance sensors used to detect changes in elevation in the road surface is a mechanical sensor. FIG. 5 is a side view of an example system 500 for refuse collection that includes a refuse collection vehicle 520, an intermediate container 502 coupled to the front loading arm assembly 504 of the vehicle 520, and a mechanical displacement sensor 506 coupled to the intermediate container 502. The mechanical displacement sensor 506 includes a telescoping arm 508 and a contact end 510. The contact end 510 can be, for example, a roller or a wheel that is in contact with the road surface 512. The telescoping arm 508 is spring biased to maintain contact between the contact end 510 and the road surface 512. A change in elevation of the road surface 512 relative to the intermediate container 502 causes the telescoping arm 508 to displace (e.g., extend or compress), and the amount displacement of the telescoping arm 508 can be used to detect changes in elevation in the road surface 302 in front of the vehicle 102.

While the mechanical displacement sensor 506 is shown as being coupled to the underside of the intermediate container 502 between a front surface 530 of the intermediate container 502 and a rear surface 532 of the intermediate container 502, one or more mechanical displacement sensors can be coupled to other portions of the intermediate container 502. For example, the mechanical displacement sensor 506 can be coupled to a front surface 530 of the intermediate container 502 or coupled to the underside of the intermediate container 502 near the front surface 530.

The mechanical displacement sensor 506 can send a signal (e.g., a CAN message) to an onboard computing device (e.g., onboard computing device 112) indicating a change in elevation (e.g., elevation angle 511) of the road surface 512. For example, the mechanical displacement sensor 506 can send a signal indicating a distance that the telescoping arm 508 has been displaced by the road surface. The onboard computing device can compare the distance displaced with a threshold elevation change.

In response to determining that the indicated elevation change exceeds a threshold elevation change, the onboard computing device can raise the intermediate container 502 to prevent damage to the intermediate container 502 resulting from elevation changes in the road surface 512. For example, the onboard computing device can raise the intermediate container until a signal is received from the mechanical displacement sensor 506 indicating a displacement of the telescoping arm is smaller than the threshold displacement.

The onboard computing device can control the position of the intermediate container 502 to maintain at least a specified distance between the bottom of the intermediate container 502 and the road surface 512 based on the signal received from the mechanical displacement sensor 506. For example, the mechanical displacement sensor can indicate displacement relative to a nominal position (e.g., the vehicle 520 on a flat road surface with the intermediate container in a lowered position). A threshold displacement of the mechanical displacement sensor 506 can be determined based on the specified distance. When the mechanical displacement sensor sends a signal indicating a displacement greater than the threshold, the onboard computing device can raise the intermediate container 502 by at least the amount of the indicated displacement by, for example, rotating the forks 522 and/or raising the lift arms 524.

Refuse collection system 500 includes additional distance sensors 514, 516 that can provide redundant distance measurements to further confirm changes in elevation in the road surface 512 detected by the mechanical displacement sensor 506. Distance sensors 514, 516 can include, for example, radar sensors, LIDAR sensors, ultrasonic sensors, laser-based distance sensors, stereo camera sensors, or three-dimensional cameras. Distance sensor 514 is coupled to the cab protector 518. Distance sensor 516 is coupled to intermediate container 502.

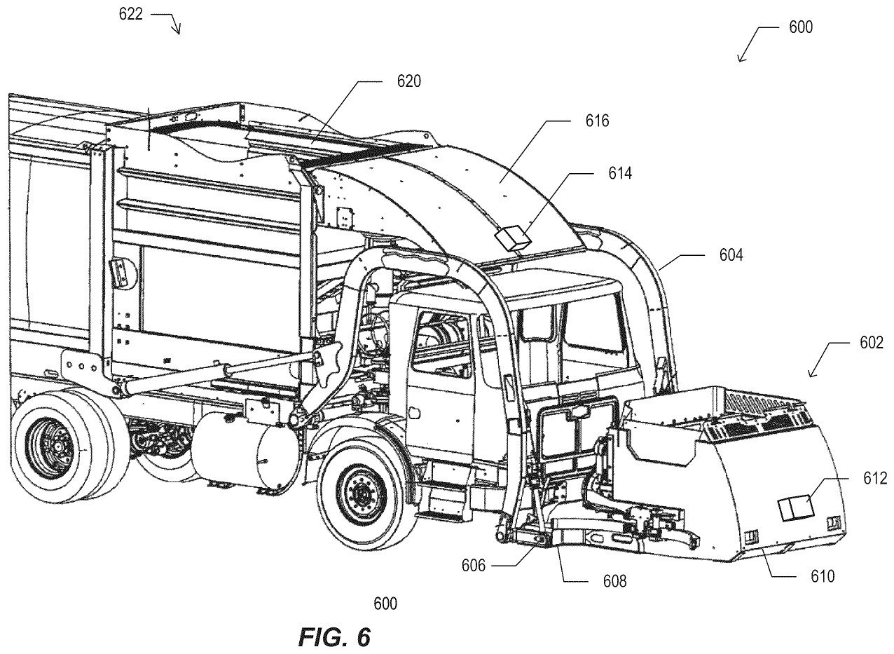

In addition, while the intermediate container 130 has been described as being coupled to the vehicle 102 via forks 113 of the vehicle 102 being inserted in channels 127 along the side of the intermediate container 130, in some implementations, the vehicle includes an integrated intermediate container. FIG. 6 is a perspective view of an example refuse collection system 600 with a refuse collection vehicle 622, an integrated intermediate container 602, and distance measurement sensors 612, 614. The front loading arms 604 of the vehicle 622 terminate at a connection end 606. The integrated intermediate container 602 is pivotally coupled to the front loading arms 604 at the connection end 606. The integrated intermediate container 602 includes substantially two parts: a frame assembly 608 and a collection bin 610. The frame assembly 608 attaches to the front loading arms 604 at connection end 606. The collection bin 610 receives and holds refuse. The intermediate container 602 can be emptied into hopper 620 by operating the front loading arms 604 similar to the process of emptying intermediate container 130 described herein. Refuse collection system 600 includes two distance sensors 612, 614 substantially similar to distance sensors 116a, 116b of FIGS. 1-3. Distance sensor 612 is coupled to a front surface of the collection bin 610. Distance sensor 614 is coupled to the cab protector 616 of the vehicle 622. Similar to distance sensors 116a, 116b, distance sensors 612, 614 are oriented toward the road surface in front of the refuse collection vehicle 622 and are configured to detect changes in elevation in changes in the road surface in front of the vehicle 622.

Further, while the refuse collection systems 100, 500, 600 have been described as including two distance sensors 116a, 116b, 514, 516, 612, 614, other numbers of distance sensors are possible (e.g., 1, 3, 4, 5 or more, etc.). In addition, while the distance sensors 116a, 116b, 514, 516, 612, 614 have been described as being coupled to a cab protector 124, 518, 616 of the vehicle 102, 520, 622 and a front surface 131 of the intermediate container 130, 502, 602, respectively, distance sensors can be attached to other portions of the vehicle 102, 520, 622, including, but not limited to, a surface of the cab of the vehicle (e.g., the roof of the cab 108, the front of the cab 108, the top of the refuse collection body proximate the hopper 117), or a surface of the lift arm of the vehicle.

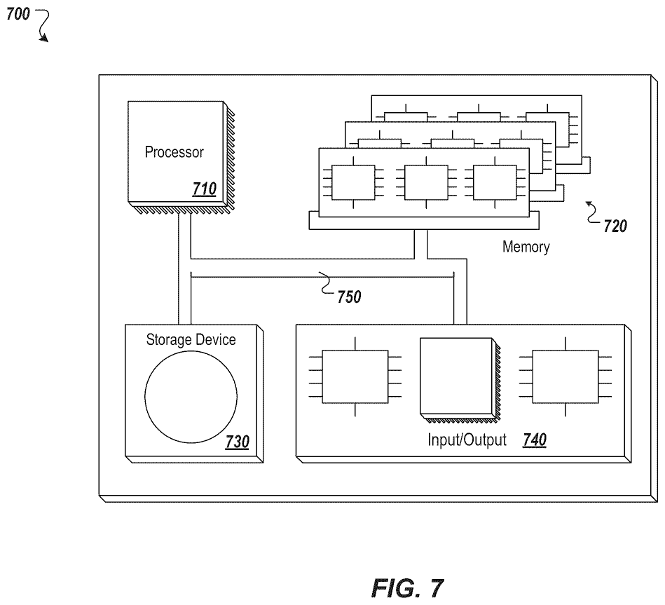

FIG. 7 depicts an example computing system, according to implementations of the present disclosure. The system 700 may be used for any of the operations described with respect to the various implementations discussed herein. For example, the system 700 may be included, at least in part, in one or more of the onboard computing device 112, and/or other computing device(s) or system(s) described herein. The system 700 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a joystick. In some implementations, the input/output device 740 includes a display unit for displaying graphical user interfaces. For example, in some implementations, the input/output device 740 is a display device that includes one or more buttons and/or a touchscreen for receiving input from a user. In some implementations, the input/output device 740 includes a keyboard and/or a pointing device. In some implementations, the input/output device 740 is located within a cab of a refuse collection vehicle (e.g., within cab 108 of vehicle 102). For example, the input/output device 740 can be attached to or incorporated within a dashboard inside the cab of a refuse collection vehicle.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A refuse collection system comprising:
a refuse collection vehicle comprising:
a chassis;
a refuse collecting body supported by the chassis; and
a front loading arm assembly coupled to the refuse collecting body;
an intermediate container for receiving refuse positioned in front of the refuse collection vehicle and coupled to the front loading arm assembly;
at least one sensor coupled to a portion of the refuse collection vehicle or to a portion of the intermediate container, the at least one sensor oriented toward a road surface in front of the refuse collection vehicle; and
at least one processor communicably coupled to the at least one sensor, the at least one processor configured to perform operations comprising:
receiving a signal from the at least one sensor; and
in response to receiving the signal, determining an elevation change of the road surface in front of the refuse collection vehicle.

2. The refuse collection system of claim 1, wherein the at least one sensor is coupled to the portion of the refuse collection vehicle and a detection distance of the at least one sensor is greater than a distance between a front side of the intermediate container and a front bumper of the refuse collection vehicle.

3. The refuse collection system of claim 2, wherein the detection distance is determined based at least in part on a speed of the refuse collection vehicle.

4. The refuse collection system of claim 1, wherein the at least one sensor comprises at least one of a radar sensor, a lidar sensor, a laser sensor, a stereo camera, a three-dimensional camera, or an ultrasonic sensor.

5. The refuse collection system of claim 1, wherein the elevation change comprises a vertical deflection traffic calming device or the elevation change comprises an increase in the elevation of the road surface.

6. The refuse collection system of claim 1, wherein the operations further comprise:
in response to determining the elevation change, controlling the front loading arm assembly to change a position of the intermediate container.

7. The refuse collection system of claim 6, wherein controlling the front loading arm assembly to change the position of the intermediate container comprises controlling the front loading arm assembly to adjust at least one of a height and an angle of the intermediate container.

8. The refuse collection system of claim 7, wherein controlling the front loading arm assembly to change the position of the intermediate container occurs while the refuse collection vehicle is in motion.

9. The refuse collection system of claim 7, wherein controlling the front loading arm assembly to change the position of the intermediate container comprises adjusting at least one of the height of the intermediate container or the angle of the intermediate container to a predetermined value.

10. The refuse collection system of claim 1, wherein the at least one sensor comprises a mechanical sensor configured to be in contact with a surface on which the refuse collection vehicle is positioned when the intermediate container is in a lowered position.

11. The refuse collection system of claim 1, wherein the at least one processor comprises an onboard computing device located in the refuse collection vehicle.

12. A refuse collection system comprising:
a refuse collection vehicle comprising:
a chassis;
a refuse collecting body supported by the chassis; and
a front loading arm assembly coupled to the refuse collecting body;
an intermediate container for receiving refuse positioned in front of the refuse collection vehicle and coupled to the front loading arm assembly;
at least one sensor coupled to a portion of the refuse collection vehicle or to a portion of the intermediate container, the at least one sensor oriented toward a road surface; and
at least one processor communicably coupled to the at least one sensor, the at least one processor configured to perform operations comprising:
receiving a signal from the at least one sensor; and
in response to receiving the signal, controlling the refuse collection vehicle to prevent damage to the intermediate container coupled to the front loading arm assembly of the refuse collection vehicle.

13. The refuse collection system of claim 12, wherein the front loading arm assembly comprises one or more position sensors; and
wherein the operations further comprise:
receiving signals from the one or more position sensors;
determining at least one of a height and an angle of the intermediate container with respect to a road surface on which the refuse collection vehicle is positioned.

14. The refuse collection system of claim 13, wherein controlling the refuse collection vehicle to prevent damage to the intermediate container comprises controlling the front loading arm assembly to adjust at least one of the height and the angle of the intermediate container.

15. The refuse collection system of claim 12, wherein the at least one processor is further configured to:
determine, based on the signal, an elevation change of the road surface in front of the refuse collection vehicle; and
based on the elevation change of the road surface, control the refuse collection vehicle to change a position of the intermediate container to prevent contact between the intermediate container and the road surface.

16. A method of operating a refuse collection vehicle, the method comprising:
receiving a signal from at least one sensor coupled to a portion of the refuse collection vehicle or to a portion of an intermediate container, the at least one sensor oriented toward a road surface in front of the refuse collection vehicle;
in response to receiving the signal, determining an elevation change of a road surface on which the refuse collection vehicle is positioned; and
in response to determining an elevation change, controlling the refuse collection vehicle to prevent damage to an intermediate container for collecting refuse coupled to a front loading arm assembly of the refuse collection vehicle.

17. The method of claim 16, wherein controlling the refuse collection vehicle to prevent damage to the intermediate container comprises controlling the front loading arm assembly to raise the intermediate container.

18. The method of claim 17, further comprising:
receiving a signal from one or more position sensors of the front loading arm assembly;
in response to receiving the signal from the one or more position sensors, determining at least one of a height of the intermediate container and an angle of the intermediate container with respect to a road surface on which the refuse collection vehicle is positioned.

19. The method of claim 18, wherein raising the intermediate container comprises:
adjusting at least one of the angle of the intermediate container relative to the road surface on which the refuse collection vehicle is positioned or the height of the intermediate container relative to the road surface on which the refuse collection vehicle is positioned to a predetermined value.

20. The method of claim 16, further comprising in response to receiving the signal, generating a visual alert or an audible alert.

21. The method of claim 16, wherein the at least one sensor comprises a mechanical sensor coupled to the portion of the intermediate container and in contact with the road surface, and
wherein receiving a signal comprises receiving a signal indicating a deflection of the mechanical sensor in response to a change in elevation of the road surface.
